(19) United States
(12) Patent Application Publication
(10) Pub. No.: US 2010/0043910 A1
(43) Pub. Date: Feb. 25, 2010

(54) Pour Spout

(75) Inventors: Alex S. Szekely, Jackson, NJ (US); Alfred J. Astoreca, Annandale, NJ (US); Peter A. Piscopo, Medford, NJ (US)

Correspondence Address: BACHMAN & LAPOINTE, P.C., 900 CHAPEL STREET, SUITE 1201, NEW HAVEN, CT, 06510, US

(73) Assignee: PLASTEK INDUSTRIES, INC., Erie, PA (US)

(21) Appl. No.: 11/911,695

(22) PCT Filed: Feb. 6, 2007
(86) PCT No.: PCT/US07/61722

§ 371 Date: Oct. 16, 2007

(51) Int. Cl. B65B 3/04; B65D 41/04; B65D 25/40; B65D 90/02; B23P 11/00

(52) U.S. Cl. 141/1; 220/288; 220/729; 220/675; 29/428

(57) ABSTRACT

A container has a body, a spout fitment, and a cap. The body has a body opening. The spout fitment is within the body opening and secured by a backlocked mechanical engagement. The cap is threadingly mounted to at least one of the body and spout fitment. The cap has a sealing surface sealingly contacting a sealing surface of at least one of the body and spout fitment.

### CROSS-REFERENCE TO RELATED APPLICATION

Benefit is claimed of U.S. Patent Application Ser. No. 60/771,091, filed Feb. 6, 2006, and entitled “Pour Spout”, the disclosure of which is incorporated by reference herein as if set forth at length.

### BACKGROUND OF THE INVENTION

The invention relates to containers. More particularly, the invention relates to pour spouts for containers for liquid laundry detergent and the like.

There has been an evolution in the configuration of containers for liquid laundry detergent, fabric softener, and the like. The dominant form of container is a wide mouth bottle having an attached spout with a drain-back trough and aperture (often identified as a drain back spout (DBS) configuration). In a typical group of container configurations and their methods of assembly, a bottle body, spout fitment, and cap are individually molded (e.g., of high density polyethylene (HDPE) for the body, polypropylene for the cap, and low density polypropylene (LDPE) for the spout fitment). Exemplary bottle body molding is via roto-molding whereas exemplary spout fitment and cap molding are by injection molding. An exemplary spout fitment includes the spout and a continuation of the spout defining the base and outboard wall of the trough. The fitment further typically includes a flange (e.g., extending outward at an upper end of the outboard extremity of the outboard wall).

The spout fitment may be inserted through a mouth of the bottle body (e.g., so that an outer surface of the outboard trough wall, or another wall outboard thereof, engages the inner surface of the bottle neck). The spout fitment may be secured and sealed to the bottle body such as by spin welding. The bottle may be filled and the cap may be installed. Exemplary caps typically have either an externally threaded skirt for engaging an internally threaded portion of the fitment or an internally threaded skirt for engaging an externally threaded portion of the fitment or bottle body neck. With a typical externally threaded skirt, the cap includes an outwardly projecting flange above the skirt. Upon installation of the cap to the fitment, the flange underside contacts and seals with the fitment flange upper surface to seal the bottle.

Various examples of bottles are shown in U.S. Pat. Nos. 6,923,341, 5,941,422, 5,566,862, and 5,603,787, the disclosures of which are incorporated by reference herein as if set forth at length.

### SUMMARY OF THE INVENTION

One aspect of the invention involves a container having a body, a spout fitment, and a cap. The body has a body opening. The spout fitment is within the body opening and secured by a backlocked mechanical engagement. The cap is threadingly mounted to at least one of the body and spout fitment. The cap has a sealing surface sealingly contacting a sealing surface of at least one of the body and spout fitment.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a sectional view of a spout fitment and cap installed to a neck area of a bottle body.

FIG. 2 is an enlarged view of the bottle body neck area of FIG. 1.

FIGS. 3 and 4 are views of an assembly of the cap and spout fitment of FIG. 1.

FIGS. 5-7 are views of the spout fitment mounted to the bottle body neck.

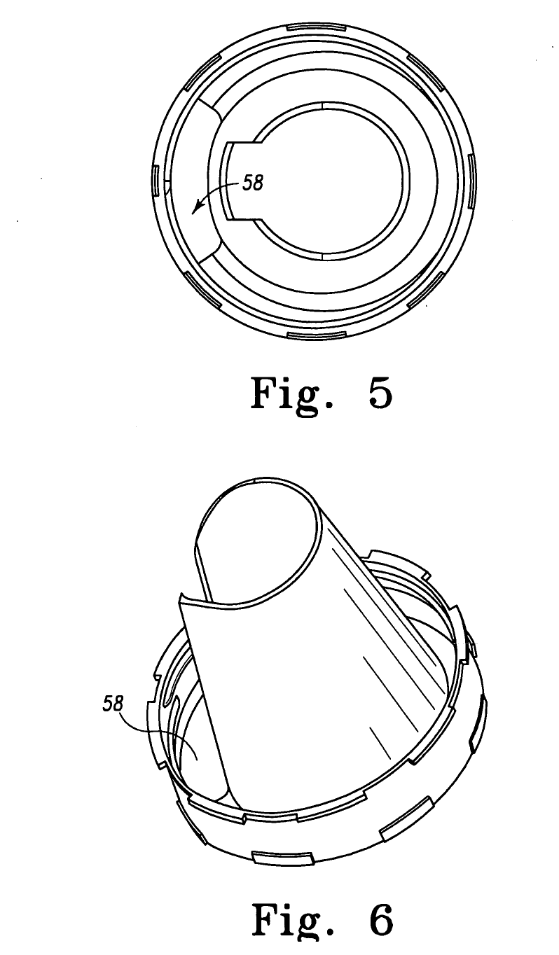

FIG. 8 is a view of the bottle body neck.

FIG. 9 is a sectional view of a second spout fitment and cap installed to a neck area of a bottle body.

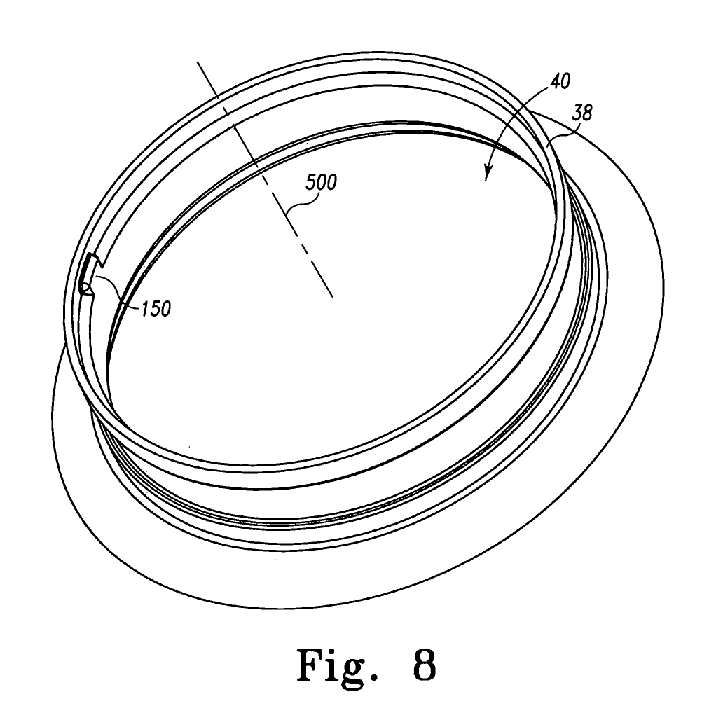

FIG. 10 is an enlarged view of the bottle body neck area of FIG. 9.

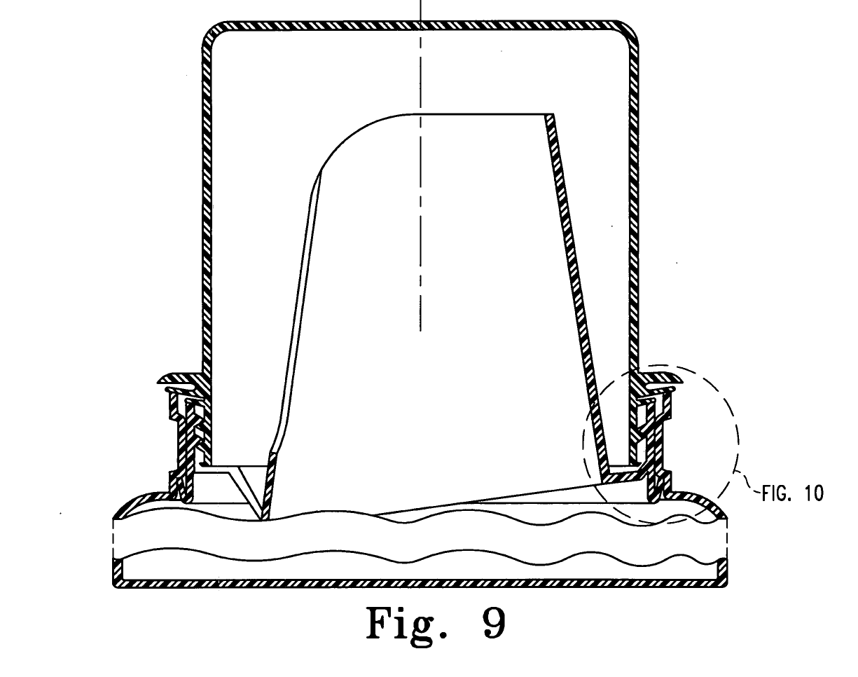

FIG. 11 is a sectional view of a third spout fitment and cap installed to a neck area of a bottle body.

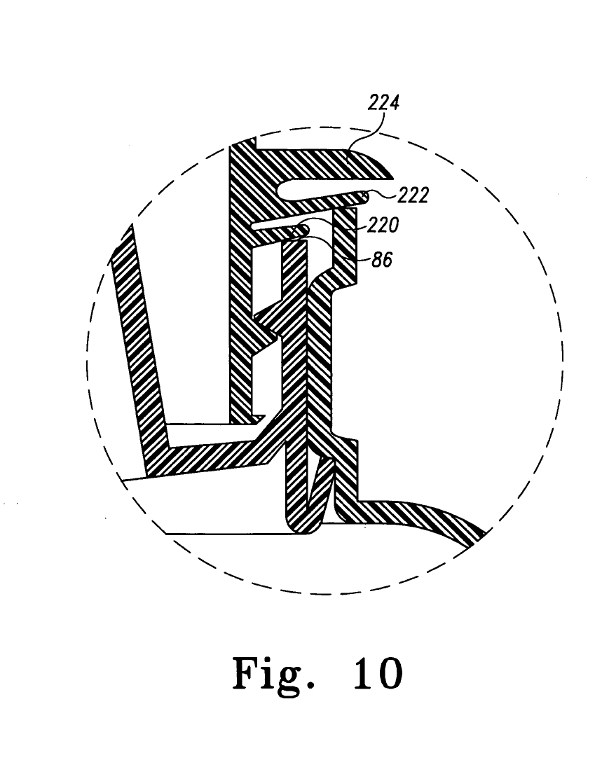

FIG. 12 is an enlarged view of the bottle body neck area of FIG. 11.

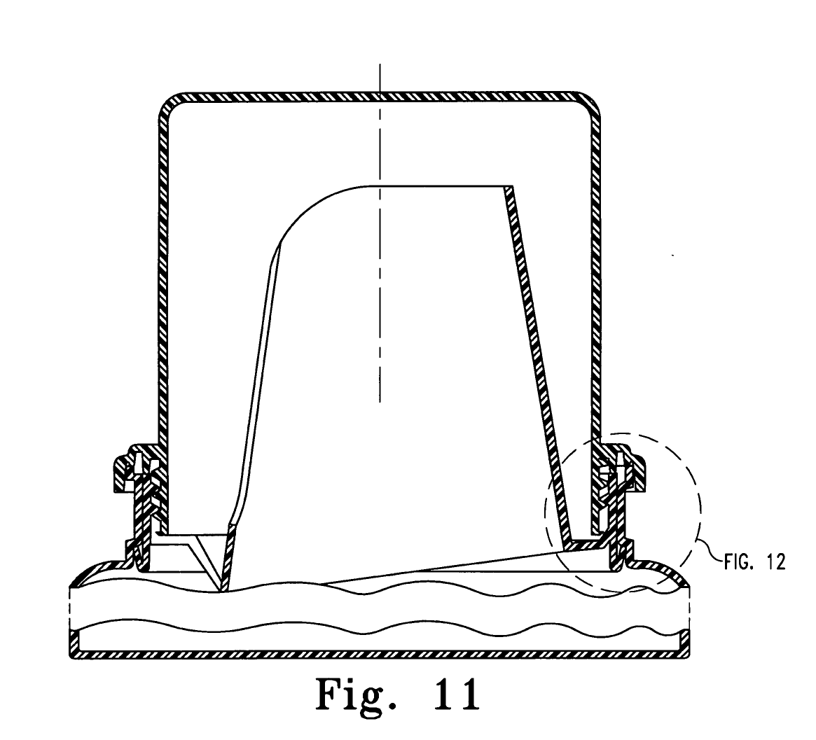

FIG. 13 is a sectional view of a fourth spout fitment and cap installed to a neck area of a bottle body.

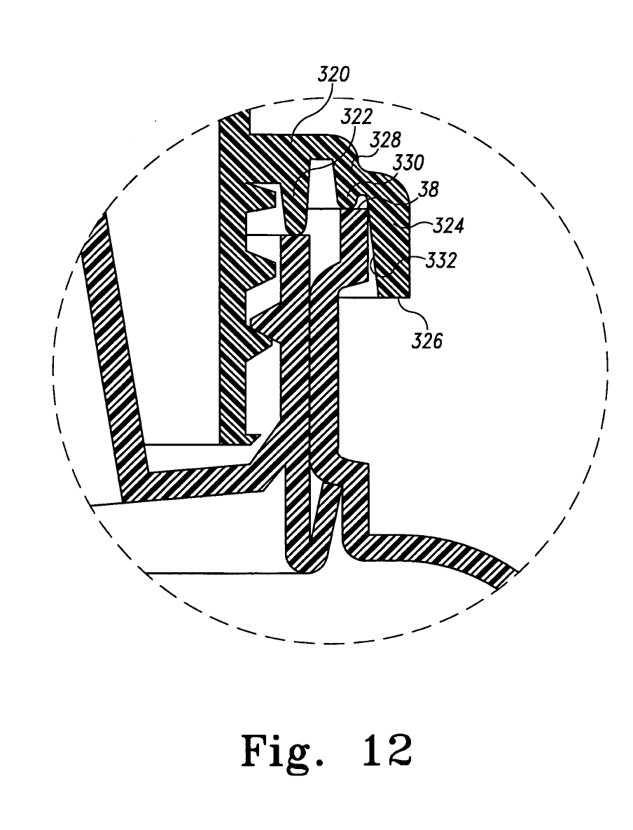

FIG. 14 is an enlarged view of the bottle body neck area of FIG. 13.

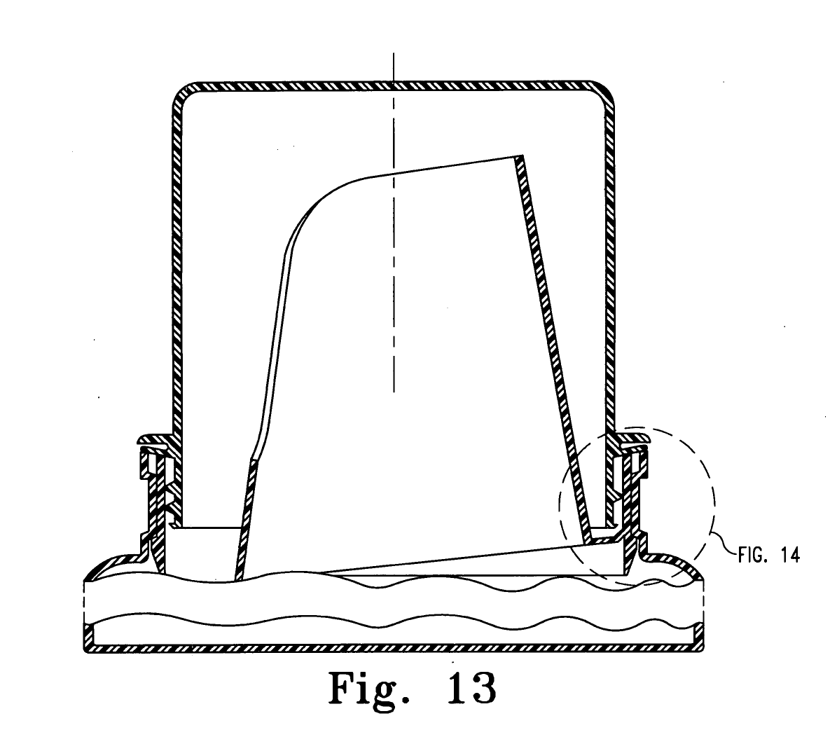

FIG. 15 is a side view of the spout fitment and cap of FIG. 13.

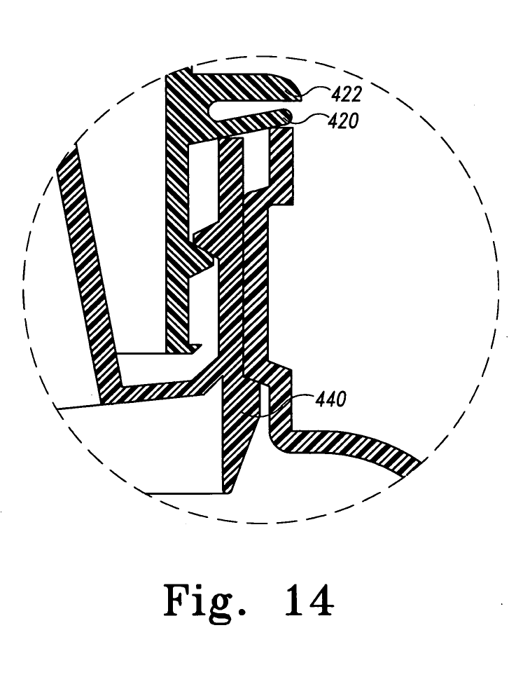

FIG. 16 is a view of the bottle body neck area circumferentially offset from the view of FIG. 14.

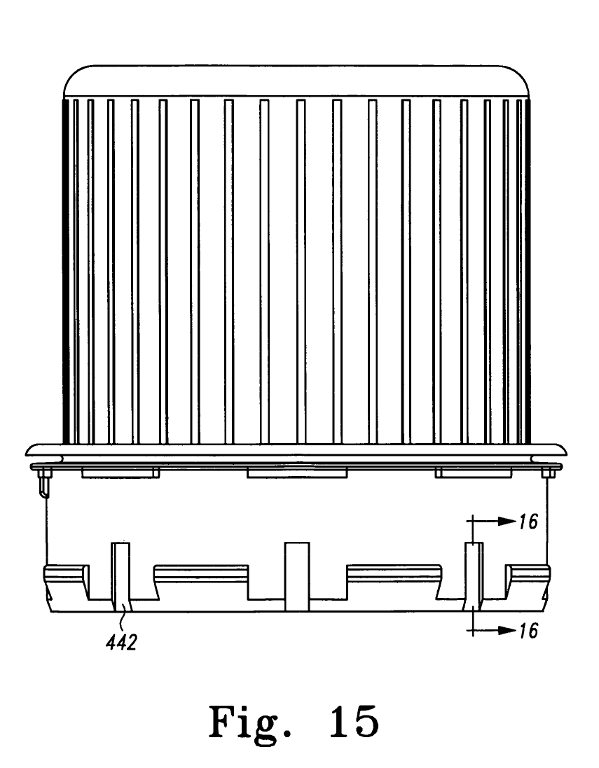

FIG. 17 is a view of the spout fitment of FIG. 13.

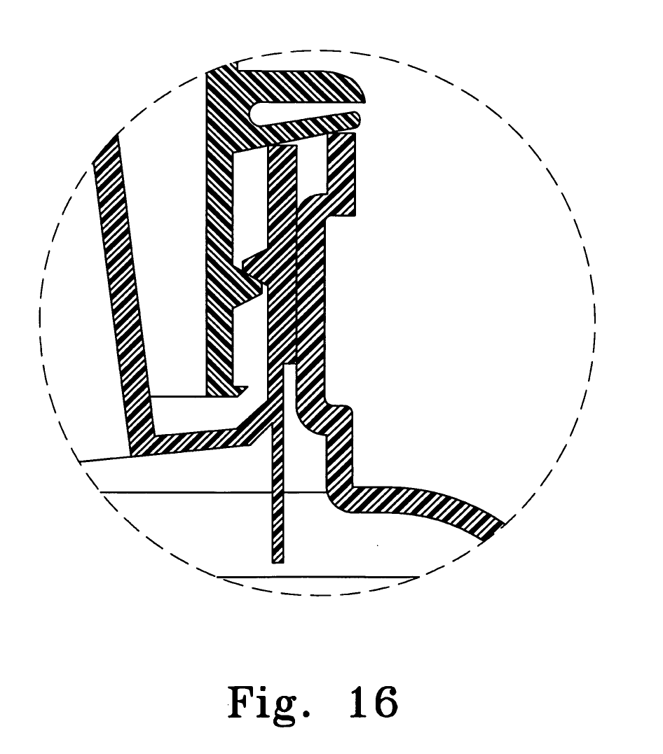

FIG. 18 is a second view of the spout fitment of FIG. 13.

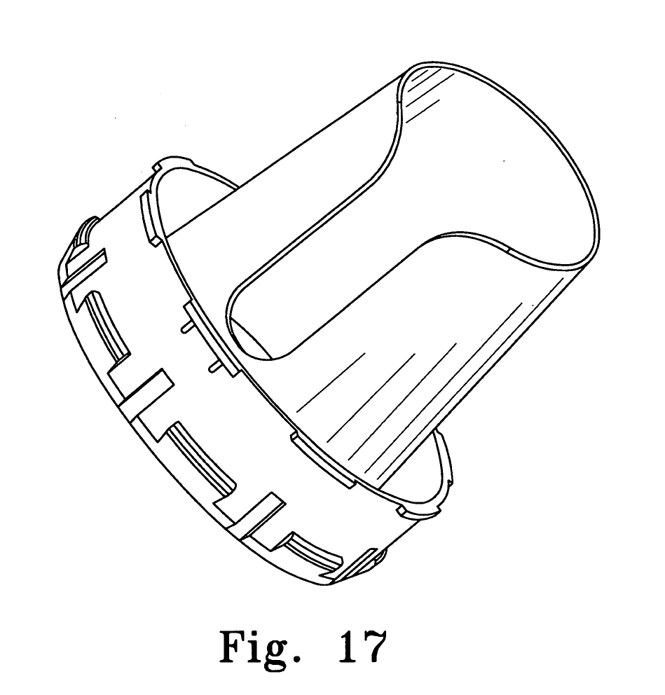

FIG. 19 is a view of a fifth spout fitment and cap installed to a neck area of the bottle.

FIG. 20 is a sectional view of the spout fitment, cap, and bottle of FIG. 20.

FIG. 21 is an enlarged view of the fitment, cap, and body of FIG. 20.

Like reference numbers and designations in the various drawings indicate like elements.

### DETAILED DESCRIPTION

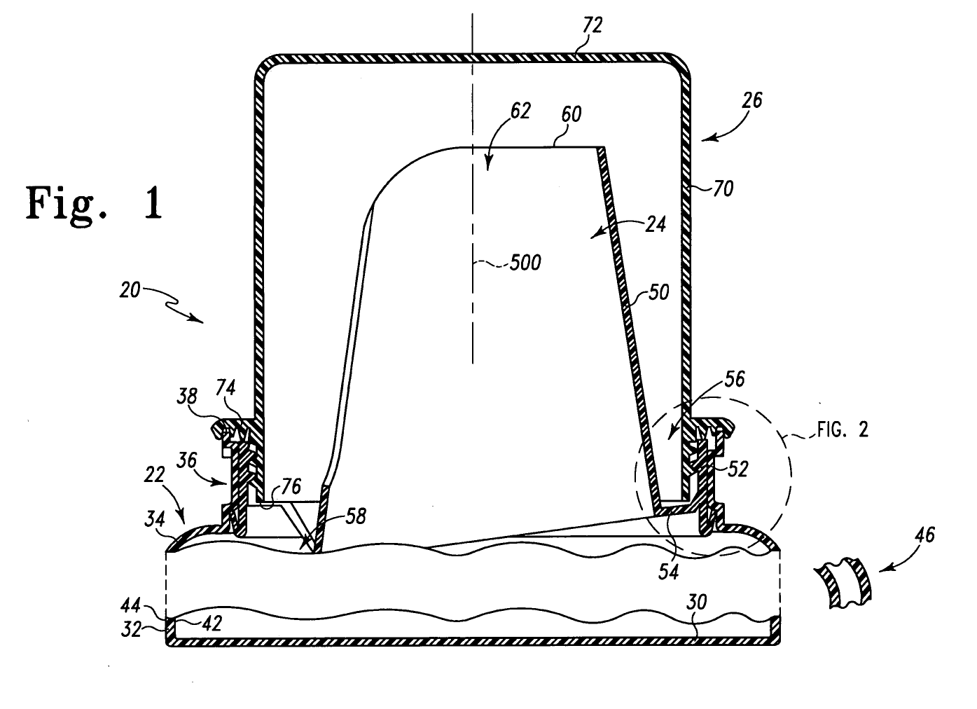

FIG. 1 shows a container 20 comprising the assembly of a bottle body 22, a spout fitment 24, and a cap 26 (which may serve as a measuring/dispensing cup). Each may be made as a unitary plastic molding. Exemplary bottle body material is high density polyethylene (HDPE). Exemplary spout fitment and cap material is polypropylene.

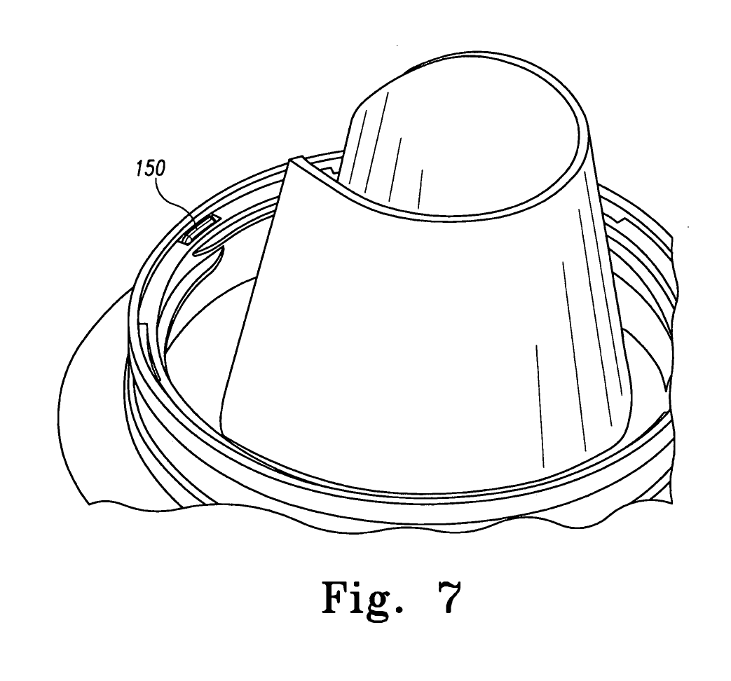

The body 22 comprises a unitary combination of a base 30, a sidewall 32 extending upward from the base, a shoulder 34 at an upper end of the sidewall, and a neck 36 extending upward from the shoulder to a rim 38 and defining an opening 40 (FIG. 8) having a central longitudinal axis 500. The bottle body has an interior surface 42 and an exterior surface 44. A handle 46 may extend from the sidewall and the body interior may extend through the handle

The spout fitment includes an inner wall 50 and an outer sidewall 52 joined by a lower wall 54 so as to define a trough 56. One or more drain-back apertures 58 are opened to the trough (e.g., through the wall 54). The wall 50 has an upper end 60 defining a spout opening 62. The upper end 60 peaks along a forward portion and dips along a rearward portion so that the opening 62 is asymmetric and defines a preferential direction for pouring.

The cap 26 includes a sidewall 70, a transverse web 72 at the upper end of the sidewall, and an outwardly projecting flange 74 spaced a short distance above a lower end 76 of the sidewall.

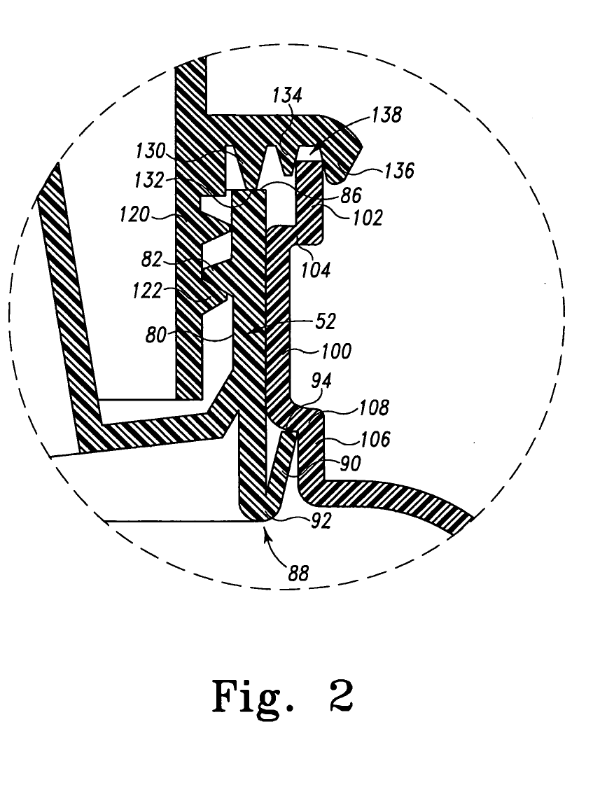

FIG. 2 shows the spout fitment sidewall 52 as having an inboard surface 80 bearing an internal thread 82. The sidewall has an external/outboard surface 84. The sidewall has an upper end 86 and a lower end 88. A circumferential array of hook barbs 90 is formed along the sidewall extending upward from the lower end 88. Each barb 90 has a proximal junction/hinge 92 with the remainder of the sidewall and an upper/distal end surface 94. As is discussed in further detail below, the surface 94 engages an adjacent surface of the bottle body to retain the spout fitment in an installed condition.

FIG. 2 further shows the bottle body neck as having an intermediate portion 100 along which the body interior surface contacts the spout fitment sidewall exterior surface 84. The neck further includes an upper portion 102 extending to the rim 38 and radially outwardly offset from the portion 100 (e.g., at a shoulder 104). Similarly, a lower portion 106 is offset (e.g., by a shoulder 108). The barb surface 94 contacts the bottle interior surface 42 along the shoulder 108 to resist upward extraction of the spout fitment.

A lower portion 120 of the cap sidewall 70 depends below the flange 74 and bears an external thread 122 engaging the internal thread 82. Depending from the underside of the flange are an inboard annular projection 130 having a lower end 132, an intermediate annular projection 134, and an outboard annular projection 136. A channel 138 is defined between the projections 134 and 136. In an installed condition, a portion of the bottle body neck near the rim 38 is sealingly captured in the channel 138.

In an exemplary method of assembly, the cap is fully or partially screwed onto the spout fitment. The spout fitment is then inserted into the bottle neck. In an initial stage of insertion, the barbs 90 are accommodated by the radially outwardly offset upper portion 102 of the neck. This accommodation permits further insertion to flex the barbs inward (e.g., compressing the gap between the barb and the sidewall and/or flexing the sidewall 52). This compression may occur in a number of ways, the portion 102, near the rim 138 may flex a distal portion of the barb. Additionally, the inner surface of the interior surface of the bottle at the shoulder 104 may inwardly flex a proximal portion and the sidewall 52.

Eventually, the barbs 90 pass over the portion 100 and relax into the locking engagement described above. Dimensions may be such that interference contact between the surface 84 and the bottle interior surface along the portion 100 provides a sealing under normal loads associated with pouring.

Advantageously, in a storage condition with the cap installed, there is direct cap-to-bottle body sealing. Exemplary sealing is caused by the interaction of the projections 134 and 136 with the bottle body rim (shown interfering in FIG. 2 due to artifacts of solid modeling). This interaction may upwardly flex the flange 74 to maintain effective sealing bias.

There may also be a sealing contact between the cap and spout fitment. In the exemplary embodiment, this contact is between the projection end 132 and sidewall upper end 86.

In one exemplary installation operation, the cap is only partially screwed on to the spout fitment (e.g., so that there is a gap between the projection end 132 and the sidewall upper end 86). Insertion of the spout fitment is in this condition. This may ease insertion due to a reduced need to flex the flange in the final stage of insertion. If the bottle was not filled prior to insertion, the cap may be unscrewed and removed so that the bottle may then be filled. The cap may be further tightened (screwed back on) to a more fully installed condition (e.g., with a final stage of flex in the flange as the body neck rim portion is accommodated in the channel 138). There may, advantageously, be a relatively lighter engagement between the projection end 132 and sidewall end 86.

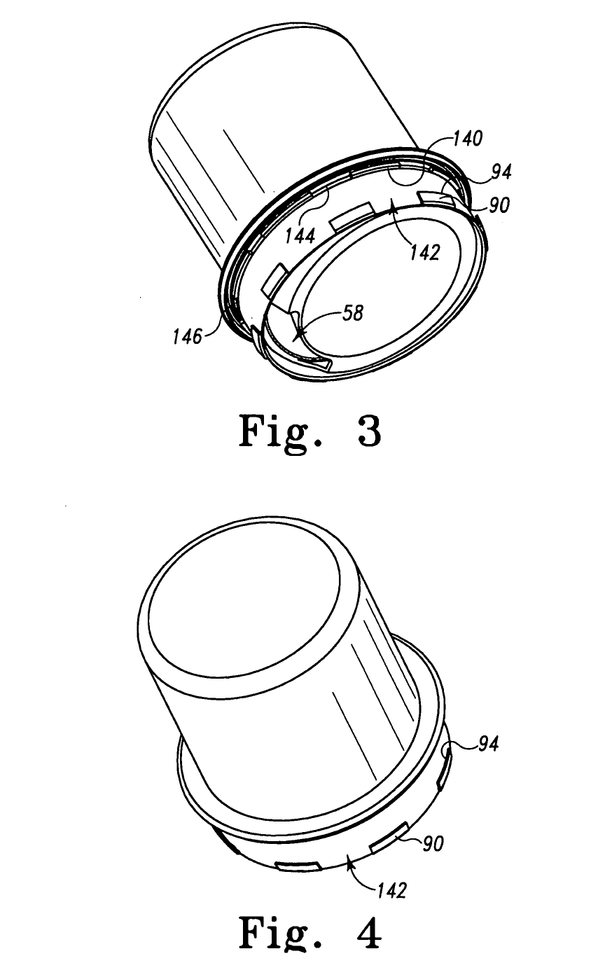

Angular registration and retention of the spout fitment may be provided. FIGS. 3 and 4 show a segmented flange 140 extending radially outward from the spout fitment sidewall at the upper end 86. In the exemplary embodiment, the segments of the flange 140 are aligned with gaps 142 between the barbs 90. The exemplary flange 140 has a series of gaps 144 and 146. There are a plurality of the gaps 144 of equal circumferential extent. The single gap 146 is of a smaller extent. The exemplary gap 146 is at the rear of the spout fitment. The bottle body neck has an inward projection 150 (FIGS. 7 and 8) which may span the junction between the upper portion 102 and shoulder 104. Upon spout fitment insertion, engagement of the flange 140 to the bottle interior surface at the shoulder 102 resists further insertion beyond the installed position thus longitudinally retaining the spout fitment. Engagement between the gap 146 and the projection 150 resists rotation of the spout fitment.

The second embodiment is otherwise similar except for the cap flange and its interaction with the spout fitment and bottle. The flange 74 is replaced by a series of a lower flange 220, an intermediate flange 222, and an upper flange 224. There may be sealing engagement between the underside of the flange 220 and the sidewall upper end 86. There may be sealing engagement between the underside of the flange 222 and the bottle body rim 38. The flanges are positioned so that the flange 222 is relatively more deformed by its engagement with the bottle body than the flange 220 is by its engagement with the spout fitment sidewall. In a fully installed condition, an outboard portion of the flange 222 may be relatively substantially deflected toward the flange 224. The flange 224 may serve as a backstop essentially preventing further deformation of the flange 222 beyond a maximum point. This may prevent over-tightening damage to the flange 222.

The third embodiment also modifies the cap flange. The flange 320 has an inboard projection 322 which may be similar to that of the first embodiment. At an outboard end of the flange 320 there is a stepped depending skirt having a distal portion 324 extending to a rim 326. A proximal portion 328 has a small downward projection 330. A combined sealing engagement may involve abutting of the projection 330 with the bottle rim 38 and inwardly compressive engagement between a tapering interior surface 332 and the bottle exterior surface along the portion 102.

In the fourth embodiment, the cap has lower and upper flanges 420 and 422. The underside of the flange 420 seals with the bottle rim and is deflected toward the upper flange 422 which serves as a backstop. Additionally, the barbs 440 are solid (e.g., as opposed to hook-like barbs with an outboard portion capable of flexing toward an inboard portion). The solid barbs increase sidewall rigidity. Accordingly, to ease sidewall insertion, there may be thinning slots 442 between the barbs.

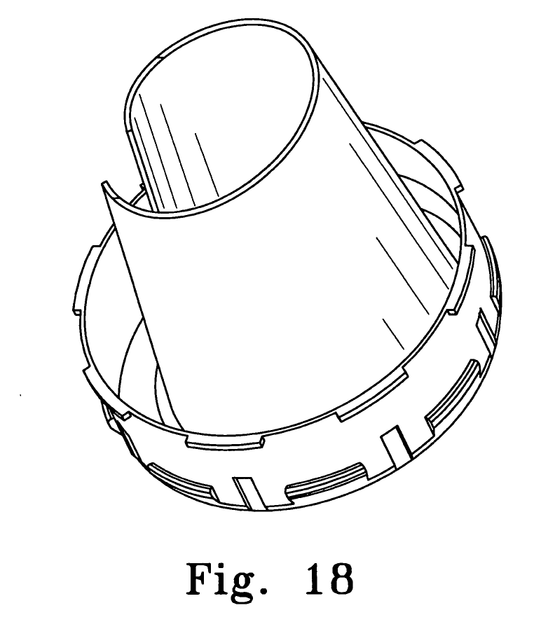

In the fifth embodiment of FIGS. 19-21, the interlocking feature of the neck is external and that of the spout fitment is internal. With a blow-molded bottle body, this allows greater precision in forming the body's interlocking and sealing features than if such features were internal.

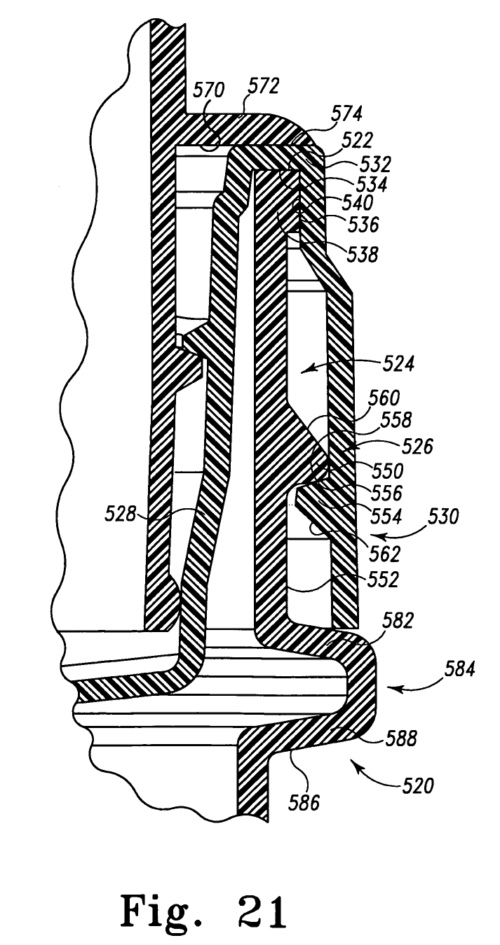

FIG. 21 shows the bottle body neck 520 extending to an upper rim 522. An upper portion 524 of the neck 520 proximal of the rim 522 is positioned radially between an outboard/outer sidewall 526 and an intermediate sidewall 528 of the spout fitment 530. The walls 526 and 528 are joined by an upper rim flange 532. The underside 534 of the flange 532 seals against the rim 522.

There may also be a radial sealing between the spout fitment and neck. In the exemplary implementation, an outboard surface 536 of a protuberance 538 of the neck at the rim 522 sealingly engages an inner/inboard surface 540 of the outer sidewall 526. The spacing between the intermediate and outer sidewalls 528 and 526 at the neck protuberance 538 may be such as to provide a radial interference fit for sealing.

The backlocking of the spout fitment to the neck is provided by interaction of an outward radial projection 550 on the outer surface 552 of the neck 520 cooperating with an inward radial projection 554 of the surface 540. The exemplary projections 550 and 554 are full annulus projections. Shown interfering, the projection 550 has an underside 556 and the projection 554 has an upper surface 558 sharply angled (e.g., close to radial) to provide mechanical backlocking. To facilitate installation, the upper surface 560 of the projection 550 and the underside 562 of the projection 554 are shallower to provide a camming action as the spout fitment is downwardly inserted for installation to the neck.

In the exemplary implementation, the underside 570 of a cap flange 572 may seal against the upper surface 574 of the flange 532 when the cap is fully installed. An exemplary intermediate wall 528 may be otherwise similarly positioned and configured to the outer walls of the other fitments and may similarly cooperate with the cap. The inner wall 576 may also be similarly configured to that of the other embodiments.

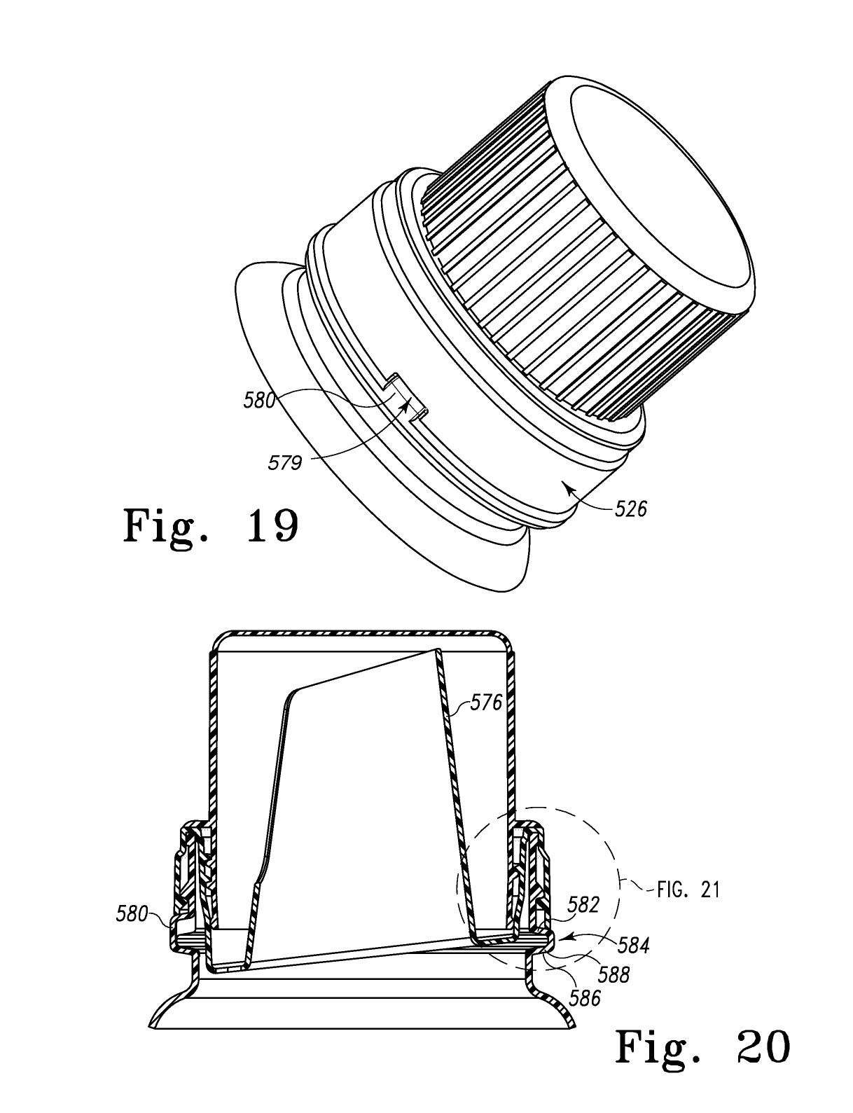

To maintain spout fitment orientation in the installed condition, the exemplary outer wall 526 includes a recess 528 (FIG. 19) which receives a projection 580. FIG. 20 shows the exemplary projection 580 as a local elevation in the upper wall 582 of a hollow flange 584. The flange 584 may serve as a transfer ring, allowing automated equipment to handle the bottle by supporting the underside 586 of the lower wall 588 of the flange 584. The bottle body may be supported via the flange 584 during fill and then the spout fitment/cap installation. Such support isolates the portion of the bottle body below the flange 584 from the pressures/forces of insertion. Thus, insertion forces may be higher than if the bottle body were supported only by its base (and with reduced chances of damage, overflow, and the like).

Various implementations may have one or more of various advantages. One group of advantages relate to elimination of welding or adhering of the spout fitment to the bottle body. In addition to the economy of a saved step, this may facilitate delivery of the liquid before attaching the spout fitment to the bottle body which may allow more efficient processing (e.g., including higher flow delivery or less precisely aimed delivery through an opening in the bottle body larger than the spout opening). The spout fitments and caps may be delivered to the bottler as units and installed in units, thereby easing installation. Other potential advantages include weight reduction and reduced intrusion of the spout fitment into the bottle body (thereby permitting higher fill levels). Other potential advantages include improved sealing. Finally, there may be greater flexibility in aesthetics by permitting relatively easy use of differently-styled spout fitments with a given bottle body or differently styled bottle bodies with a given spout fitment.

One or more embodiments of the present invention have been described. Nevertheless, it will be understood that various modifications may be made without departing from the spirit and scope of the invention. For example, when implemented in the reengineering of an existing container configuration, details of the existing configuration may influence or dictate details of any particular implementation. Accordingly, other embodiments are within the scope of the following claims.

1. A container comprising:
a body having:
a neck extending to a body opening and having a neck projection;
a spout fitment within the body opening and secured by a backlocked mechanical engagement and having a recess capturing the neck projection to resist rotation of the spout fitment relative to the body; and
a cap threadingly mounted to at least one of the body and spout fitment and having a sealing surface sealingly contacting a sealing surface of at least one of the body and spout fitment.

2. The container of claim 1 wherein:
the spout fitment comprises:
an inner wall;
an intermediate wall; and
an outer wall; and
the neck has:
a rim at the body opening; and
an upper portion proximal of the rim and between the intermediate wall and outer wall.

3. The container of claim 2 wherein:
the backlocked mechanical engagement is provided by an inward projection on the spout fitment outer wall and an outward projection on the neck upper portion.

4. The container of claim 3 wherein:
at least one of the inward projection on the spout fitment outer wall and the outward projection on the neck upper portion is a full annulus projection.

5. The container of claim 1 wherein:
the fitment comprises at least one barb providing the backlocked mechanical engagement.

6. The container of claim 1 wherein:
the fitment comprises a circumferential array of barbs providing the backlocked mechanical engagement.

7. (canceled)

8. The container of claim 1 wherein:
the fitment comprises a trough with at least one drain aperture.

9. The container of claim 1 wherein:
a portion of the cap is externally threaded to threadingly engage an internally threaded portion of the fitment.

10. The container of claim 1 wherein:
a portion of the cap is internally threaded to threadingly engage an externally threaded portion of the body.

11. The container of claim 1 wherein:
the body consists essentially of HDPE;
the spout fitment consists essentially of polypropylene; and
the cap consists essentially of polypropylene.

12. The container of claim 1 wherein:
the body has an integrally molded handle; and
an interior compartment of the body extends through the handle.

13. The container of claim 1 wherein:
the fitment is neither adhered nor welded to the body.

14. The container of claim 1 wherein:
the fitment is not threadingly engaged to the body.

15. The container of claim 1 wherein:
the cap sealing surface is along an underside of a flange of the cap.

16. The container of claim 1 wherein:
the cap sealing surface is along an underside of a flange of the cap.

17. The container of claim 1 wherein:
the cap sealing surface is formed by inboard and outboard walls of a downwardly open channel;
the body sealing surface is formed by a rim region of the body captured within the channel.

18. The container of claim 17 wherein:
the first flange is positioned to permit strained contact with the second flange;
in a removed state of the cap, the first flange is non-contacting with the second flange.

19. The container of claim 1 further comprising:
1.0-6.0 liters of a liquid within the body.

20. The container of claim 1 further comprising:
at least 1.0 liter of liquid detergent or fabric softener within the body.

21. A container cap and spout assembly comprising:
a spout fitment having:
a spout having an opening;
a sidewall having an internal thread and a plurality of external barbs;
a trough between the spout and sidewall; and
a drain aperture open to the trough; and
a cap having:
an external thread engaged to the spout fitment sidewall internal thread; and
a flange.

22. The assembly of claim 21 wherein:
the opening is asymmetric.

23. The assembly of claim 21 consisting essentially of the spout fitment and cap, each consisting essentially of a single molding.

24. The assembly of claim 21 wherein:
the body consists essentially of HDPE;
the spout fitment consists essentially of polypropylene; and
the cap consists essentially of polypropylene.

25. A container body comprising the unitarily molded combination of:
a base;
a sidewall extending upward from the base;
a neck having:
a distal first portion defining an opening;
a second portion below the first portion; and
a third portion below the second portion,
wherein an interior surface of the neck has:
a circular cross-section along at least part of the second portion;
at least one inward projection in the first portion; and
at least one location of on the third portion radially outboard of said circular section.

26. The container body of claim 25 further comprising:
an integrally molded handle.

27. The container body of claim 25 wherein:
no one of the at least one inward projection has a circumferential extent more than 10°.

28. The container body of claim 25 wherein:
the projection is recessed from the rim.

29. The container body of claim 25 wherein:
the neck is unthreaded.

30. A method comprising:
delivering at least 1.0 liter of a liquid into a container body;
inserting a spout fitment into a neck portion of the container body, the inserting being after the delivering and comprising a resilient deformation of at least one of the spout fitment and container body followed by an at least partial relaxation so as to engage a locking surface of the spout fitment to a locking surface of the container body to resist a reverse extraction; and
threading a cap onto at least one of the spout fitment and container body.

31. The method of claim 30 wherein:
the threading is at least partially before the inserting.

32. The method of claim 30 wherein:
the inserting consists essentially of a linear insertion; and
the inserting flexes a barb of the spout fitment, the spout fitment locking surface comprising a trailing end of the barb.

33. The method of claim 30 wherein:
the threading or a further threading brings a flange of the cap into direct sealing contact with a rim of the container body.

34. The method of claim 33 wherein:
the direct sealing contact comprises capture of the rim in a channel along the underside of the flange.

35. The method of claim 33 wherein:
the flange is a first flange and the threading or further threading flexes the first flange into contact with a second flange of the cap.

36. (canceled)

37. (canceled)

38. The method of claim 36 wherein:
there is no welding or adhesive bonding of the spout fitment to the container body before the delivering.

39. The method of claim 30 further comprising:
during the inserting, supporting the container body via a flange along the neck portion.

40. The container of claim 1 wherein:
the body has a hollow neck flange, the projection extending from the hollow neck flange.

41. The container of claim 40 wherein:
the hollow neck flange is positioned to permit the body to be supported from an underside of the hollow neck flange during filling of the body with a liquid.

42. A container comprising:
a body having:
a neck extending to a body opening; and
a hollow neck flange;
a spout fitment within the body opening and secured by a backlocked mechanical engagement; and
a cap threadingly mounted to at least one of the body and spout fitment and having a sealing surface sealingly contacting a sealing surface of at least one of the body and spout fitment.

43. A container comprising:
a body having a body opening;
a spout fitment within the body opening and secured by a backlocked mechanical engagement against longitudinal extraction and by means on the body and on the fitment for preventing relative rotation of the body and the fitment about a central longitudinal axis of the opening; and
a cap threadingly mounted to at least one of the body and spout fitment and having a sealing surface sealingly contacting a sealing surface of at least one of the body and spout fitment.
